(19) United States
(12) Patent Application Publication
(10) Pub. No.: US 2018/0094543 A1
(43) Pub. Date: Apr. 5, 2018

(54) INSERT APPARATUS AND SYSTEM FOR OIL NOZZLE BOUNDARY LAYER INJECTION

(71) Applicant: General Electric Company, Schenectady, NY (US)

(72) Inventors: Ning Fang, West Chester, OH (US); Gary Paul Moscarino, Cincinnati, OH (US); Bala Corattiyil, Montgomery, OH (US); Ramon Themudo, Cincinnati, OH (US); Prasad Laxman Kane, Woking (GB); James Mathew Suding, West Chester, OH (US)

(21) Appl. No.: 15/721,986

(22) Filed: Oct. 2, 2017

(30) Foreign Application Priority Data
Oct. 3, 2016 (IN) 201641033763

(51) Int. Cl. F01D 25/18

(52) U.S. Cl. CPC F01D 25/18; F02C 7/06

(57) ABSTRACT

An apparatus and system for injecting fluid into a boundary layer of a flow of fluid are provided. The boundary layer injection insert assembly includes an insert body and a central bore extending through the insert body from an inlet opening positioned at a first end to an outlet opening positioned at a second end of the insert body opposite the first end. The insert body is approximately cylindrical about a longitudinal axis and includes a thickness in a radial direction orthogonal to the longitudinal axis. The first end includes a plurality of injection holes extending through the thickness for a first distance, the first distance being less than the length. The boundary layer injection insert assembly also includes an annular spacer at least partially surrounding the second end and including a radially inner surface and a radially outer surface spaced apart by a thickness of the annular spacer.

### BACKGROUND

The field of the disclosure relates generally to gas turbine engines and, more particularly, to an apparatus and system for enhancing oil jet streams in an oil nozzle.

At least some known high-speed turbine machinery use dedicated nozzles to provide oil lubrication to key rotating hardware, such as bearings, gears, and the like. The oil is delivered to specific locations, such as, but not limited to, bearing rolling elements, oil scoops, carbon seals, gear mesh areas, gaps between bearing cage, guide flanges, to maximize the lubrication to those areas and also to the interior of air tubes for cooling purposes. Under high-speed rotation where windage is strong, the oil jet stream is impaired by the windage effects. In some cases, the flow stream is broken by the windage effects, depriving the location with oil flow for brief periods of time until the oil jet stream is restored. Brooming of the oil jet stream may occur when a nozzle jet is not performing well and jet integrity is lost or reduced. A broomed oil jet stream not only fails to deliver required amount of lubricant to the desired locations, but also tends to generate unnecessary heat due to stronger churning.

Oil jet stream brooming is a very complicated problem in oil nozzle design. Uniform oil flow with a minimum of a turbulent kinetic energy and velocity variation profile at the orifice is desired for a good jet stream. It is usually required to have a smooth transition of piping and larger length to orifice diameter ratio (L/D). However, in many cases, limited space and complex upstream geometric conditions make it impossible to have desired mechanical and geometric characteristics. High pressure oil lubricating and supply systems make the oil jet stream prone to brooming.

Controlled brooming may be desirable in certain applications when for example, cooling a wide area is desired. Controlled brooming is the result of a careful design and proper flow and pressure conditions. Current attempts at controlled brooming have not produced reliable and repeatable results.

Furthermore, a significant amount of pressure energy delivered by the lube oil pump is lost inside the nozzle. Recirculation regions combined with small diameters cause the large pressure drop inside the oil nozzle.

Such problems have largely been addressed at each application by past experience. Many factors, as mentioned above like upstream geometry, L/D (length/diameter ratio), etc., are adjusted based on space available, piping routes available, and by adjusting oil pumping capability and/or flow characteristics, such as, but not limited to viscosity to facilitate establishing an adequate oil jet stream. Special manufacturing processes, including proprietary procedures of nozzle suppliers are also used in an attempt to improve the integrity of the oil jet stream.

### BRIEF DESCRIPTION

In one aspect, a boundary layer injection insert assembly includes an insert body and a central bore extending through the insert body from an inlet opening positioned at a first end to an outlet opening positioned at a second end of the insert body opposite the first end. The insert body is approximately cylindrical about a longitudinal axis and includes a thickness in a radial direction orthogonal to the longitudinal axis. The first end includes a plurality of injection holes extending through the thickness for a first distance. The first distance being less than the length. The boundary layer injection insert assembly also includes an annular spacer at least partially surrounding the second end and including a radially inner surface and a radially outer surface spaced apart by a thickness of the annular spacer.

In another aspect, an oil nozzle includes a hollow elongate body coupled in flow communication to a source of a pressurized lubricating oil and a boundary layer injection insert coupled to an inner surface of the body. The boundary layer injection insert includes an insert tube including an insert body and a central bore extending through the insert body from an inlet opening positioned at a first end of the insert body to an outlet opening positioned at a second end of the insert body. The second end is positioned opposite the first end. The insert body extends circumferentially about a longitudinal axis and includes a thickness in a radial direction orthogonal to the longitudinal axis. The insert body also includes a plurality of injection holes extending through the thickness for a first distance along a length of the insert body, the first distance being less than the length. The insert body further includes an annular spacer at least partially surrounding the second end. The annular spacer includes a radially inner surface and a radially outer surface spaced apart by a thickness of the annular spacer.

In yet another aspect, a gas turbine engine includes a core engine configured to generate a flow of high energy combustion gases, a fan assembly powered by a power turbine driven by the combustion gases, and an oil lubricating and supply system configured to channel a flow of pressurized lubricating fluid to one or more components of the gas turbine engine. The oil lubricating and supply system includes a nozzle including a hollow elongated nozzle body coupled in flow communication with a source of a pressurized lubricating fluid and a boundary layer injection insert coupled to an inner surface of the nozzle body. The boundary layer injection insert includes an insert body having a central bore extending through the insert body between an inlet opening and an outlet opening. The insert body extends circumferentially about a longitudinal axis and including a thickness in a radial direction orthogonal to the longitudinal axis. The insert body also includes a plurality of injection holes extending through the thickness for a first distance along a length of the insert body. The first distance is less than the length. The insert body further includes a flange at least partially surrounding a portion of the insert body. The flange is configured to couple the insert body to the nozzle body.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an aircraft.

FIG. 2 is a schematic cross-sectional view of gas turbine engine that may be used with the aircraft shown in FIG. 1 in accordance with an exemplary embodiment of the present disclosure.

FIG. 3 is a cross-sectional view of a portion of the core turbine engine shown in FIG. 2 including the boundary layer injection insert (also shown in FIG. 2).

FIG. 4 is an enlarged view of the cross-sectional view shown in FIG. 3 of the core turbine engine (shown in FIG. 2).

FIG. 5 is a perspective cutaway view of a boundary layer injection insert assembly in accordance with an example embodiment of the present disclosure.

FIG. 6 is a side cutaway view of the insert body shown in FIG. 5 in accordance with an example embodiment of the present disclosure.

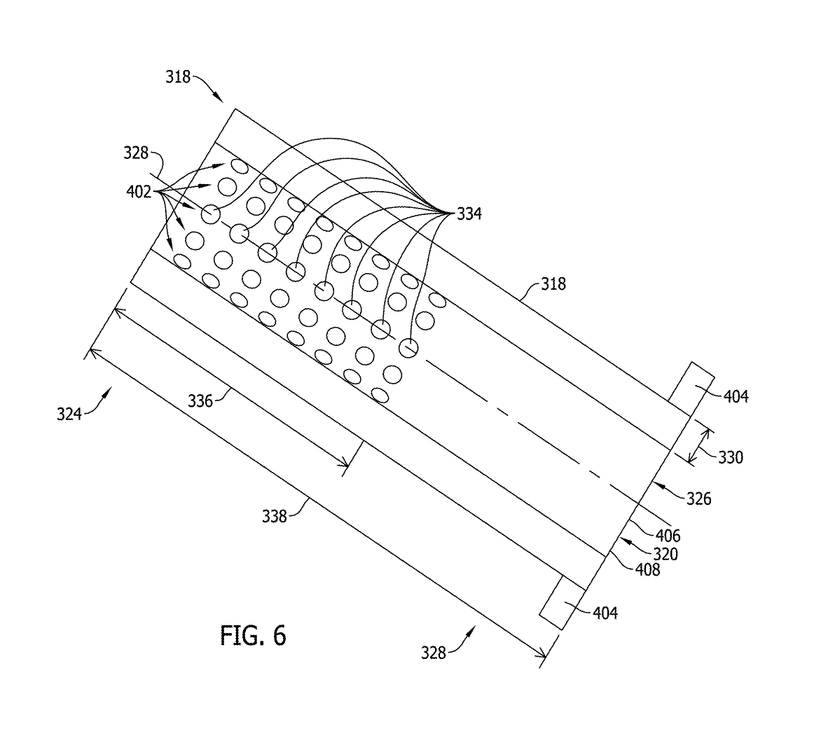

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “axial” and “axially” refer to directions and orientations that extend substantially parallel to a centerline of the nozzle body orientation. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Embodiments of the oil nozzle having a boundary layer injection insert described herein provide a cost-effective apparatus for improving an oil jet stream exiting the oil nozzle. An oil nozzle with good stream integrity is important for the healthy operation of rotating components as well as for the whole of a rotatable machine, such as, a gas turbine engine. An oil nozzle with a uniform jet stream is important for meeting target requirements. The oil nozzle and boundary layer injection insert is formed for stringent stream integrity requirements. A series of injection holes are formed on an upstream portion of the insert. Oil flow from the injection holes joins the main flow and the combined flow supplies the nozzle orifice. Any flow recirculation, and skewness of velocity and turbulence kinetic energy distribution, which are key contributors to oil jet brooming, can be corrected by the boundary layer injection induced by the injection holes. Oil jet streams experiencing less than satisfactory stream characteristics can be improved, and a more uniform oil jet stream can be achieved. The oil jet stream can be precisely delivered to the target and the lubrication of the machinery can be ensured. In addition, injection of oil in the boundary layer through these holes reduces the pressure loss through the nozzle. A significant reduction in the pressure drop through the nozzle can help to reduce a size of the lube oil pump.

Side flow injection on the main stream eliminates local recirculation and corrects any skewness of velocity and kinetic energy profiles, which are the two key contributors of nozzle jet brooming. The boundary layer injection insert provides oil jet stream integrity within limited space, is usable in very high oil supply pressures and temperature, which are the trend of advanced engine systems, and increases lubrication efficiency (oil scoop capture efficiency) and reduces overall flow requirements, such as, reduces engine oil volume. The boundary layer injection insert also enhances the integrity of oil jet stream, which facilitates oil capturing efficiency and also reduces potential oil churning and heat generation.

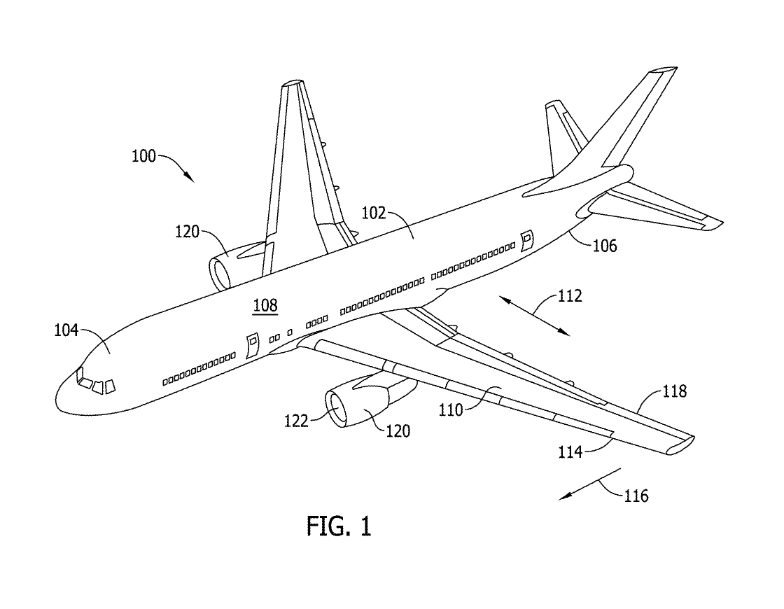

FIG. 1 is a perspective view of an aircraft 100. In the example embodiment, aircraft 100 includes a fuselage 102 that includes a nose 104, a tail 106, and a hollow, elongate body 108 extending therebetween. Aircraft 100 also includes a wing 110 extending away from fuselage 102 in a lateral direction 112. Wing 110 includes a forward leading edge 114 in a direction 116 of motion of aircraft 100 during normal flight and an aft trailing edge 118 on an opposing edge of wing 110. Aircraft 100 further includes at least one engine 120, such as, but not limited to a turbofan engine, configured to drive a bladed rotatable member, such as, fan 122 to generate thrust. At least one engine 120 is connected to an engine pylon 124, which may connect the turbofan engine at least one engine 120 to aircraft 100. Engine pylon 124, for example, may couple at least one engine 120 to at least one of wing 110 and fuselage 102, for example, in a pusher configuration (not shown) proximate tail 106.

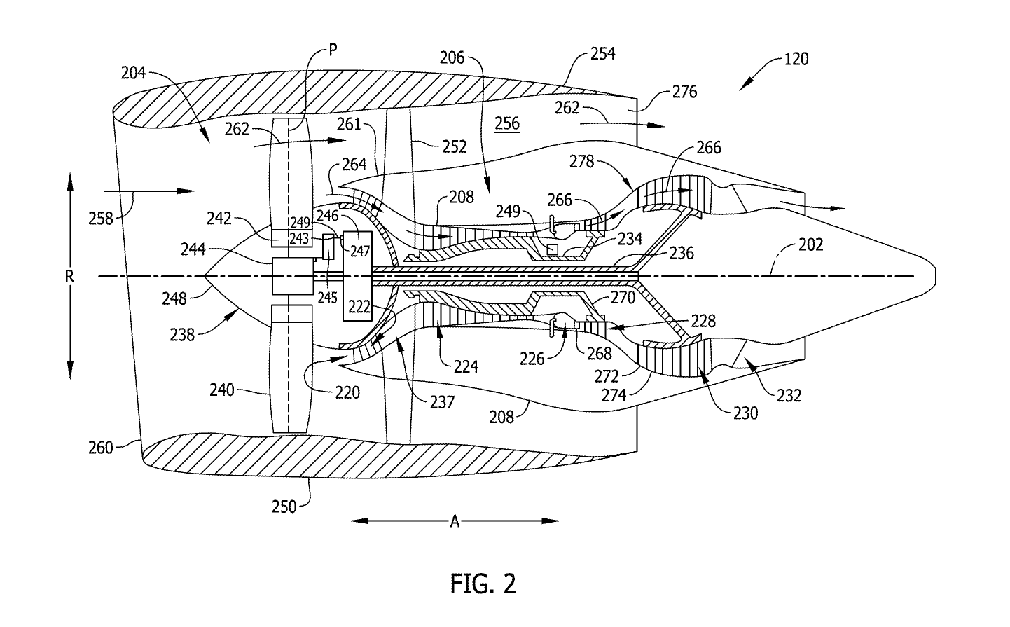

FIG. 2 is a schematic cross-sectional view of gas turbine engine 120 in accordance with an exemplary embodiment of the present disclosure. In the example embodiment, gas turbine engine 120 is embodied in a high-bypass turbofan jet engine. As shown in FIG. 2, turbofan engine 120 defines an axial direction A (extending parallel to a longitudinal axis 202 provided for reference) and a radial direction R. In general, turbofan 120 includes a fan assembly 204 and a core turbine engine 206 disposed downstream from fan assembly 204.

In the example embodiment, core turbine engine 206 includes an engine case 208 that defines an annular inlet 220. Engine case 208 at least partially surrounds, in serial flow relationship, a compressor section including a booster or low pressure (LP) compressor 222 and a high pressure (HP) compressor 224; a combustion section 226; a turbine section including a high pressure (HP) turbine 228 and a low pressure (LP) turbine 230; and a jet exhaust nozzle section 232. A high pressure (HP) shaft or spool 234 drivingly connects HP turbine 228 to HP compressor 224.

A low pressure (LP) shaft or spool 236 drivingly connects LP turbine 230 to LP compressor 222. The compressor section, combustion section 226, turbine section, and jet exhaust nozzle section 232 together define a core air flowpath 237.

In the example embodiment, fan assembly 204 includes a variable pitch fan 238 having a plurality of fan blades 240 coupled to a disk 242 in a spaced apart relationship. Fan blades 240 extend radially outwardly from disk 242. Each fan blade 240 is rotatable relative to disk 242 about a pitch axis P by virtue of fan blades 240 being operatively coupled to a suitable pitch change mechanism (PCM) 244 configured to vary the pitch of fan blades 240. In other embodiments, pitch change mechanism (PCM) 244 is configured to collectively vary the pitch of fan blades 240 in unison. Fan blades 240, disk 242, and pitch change mechanism 244 are together rotatable about longitudinal axis 202 by LP shaft 236 across a power gear box 246. Power gear box 246 includes a plurality of gears for adjusting the rotational speed of fan 238 relative to LP shaft 236 to a more efficient rotational fan speed. An oil lubricating and supply system 245 directs an oil jet stream 247 to PCM 244 and/or power gear box 246 through an oil nozzle assembly 243 including a boundary layer injection insert 249.

Disk 242 is covered by rotatable front hub 248 aerodynamically contoured to promote an airflow through the plurality of fan blades 240. Additionally, fan assembly 204 includes an annular fan casing or outer nacelle 250 that circumferentially surrounds fan 238 and/or at least a portion of core turbine engine 206. In the example embodiment, nacelle 250 is configured to be supported relative to core turbine engine 206 by a plurality of circumferentially-spaced outlet guide vanes 252. Moreover, a downstream section 254 of nacelle 250 may extend over an outer portion of core turbine engine 206 so as to define a bypass airflow passage 256 therebetween.

During operation of turbofan engine 120, a volume of air 258 enters turbofan 120 through an associated inlet 260 of nacelle 250 and/or fan assembly 204. As volume of air 258 passes across fan blades 240, a first portion 262 of volume of air 258 is directed or routed into bypass airflow passage 256 and a second portion 264 of volume of air 258 is directed or routed into core air flowpath 237, or more specifically into LP compressor 222. A ratio between first portion 262 and second portion 264 is commonly referred to as a bypass ratio. The pressure of second portion 264 is then increased as it is routed through high pressure (HP) compressor 224 and into combustion section 226, where it is mixed with fuel and burned to provide combustion gases 266.

Combustion gases 266 are routed through HP turbine 228 where a portion of thermal and/or kinetic energy from combustion gases 266 is extracted via sequential stages of HP turbine stator vanes 268 that are coupled to engine case 208 and HP turbine rotor blades 270 that are coupled to HP shaft or spool 234, thus causing HP shaft or spool 234 to rotate, which then drives a rotation of HP compressor 224. Combustion gases 266 are then routed through LP turbine 230 where a second portion of thermal and kinetic energy is extracted from combustion gases 266 via sequential stages of LP turbine stator vanes 272 that are coupled to engine case 208 and LP turbine rotor blades 274 that are coupled to LP shaft or spool 236, which drives a rotation of LP shaft or spool 236 and LP compressor 222 and/or rotation of fan 238.

Combustion gases 266 are subsequently routed through jet exhaust nozzle section 232 of core turbine engine 206 to provide propulsive thrust. Simultaneously, the pressure of first portion 262 is substantially increased as first portion 262 is routed through bypass airflow passage 256 before it is exhausted from a fan nozzle exhaust section 276 of turbofan 120, also providing propulsive thrust. HP turbine 228, LP turbine 230, and jet exhaust nozzle section 232 at least partially define a hot gas path 278 for routing combustion gases 266 through core turbine engine 206.

Turbofan engine 120 is depicted in the figures by way of example only, in other exemplary embodiments, turbofan engine 120 may have any other suitable configuration including for example, a turboprop engine, a military purpose engine, and a marine or land-based aero-derivative engine.

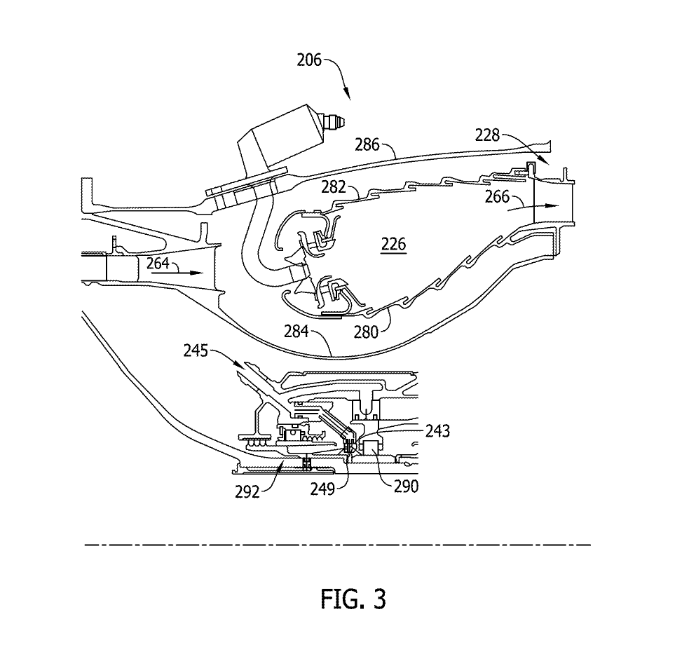

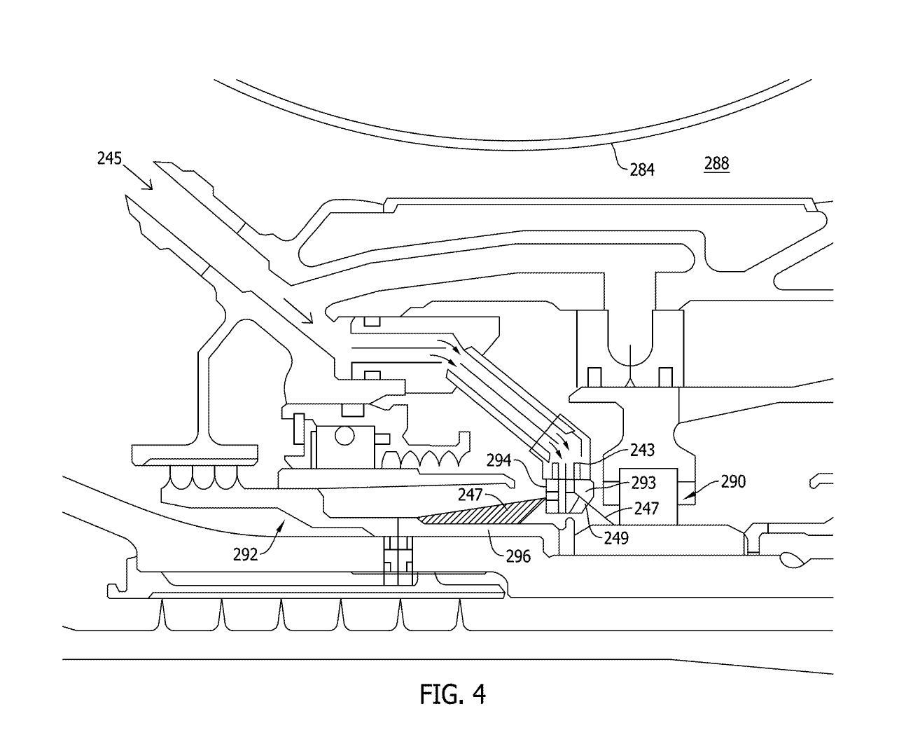

FIG. 3 is a cross-sectional view of a portion of core turbine engine 206 (shown in FIG. 2) including boundary layer injection insert 249. FIG. 4 is an enlarged view of the cross-sectional view (shown in FIG. 3) of core turbine engine 206. Combustion section 226 includes an inner liner assembly 280 and an outer liner assembly 282 comprised of a plurality of panels, an aft panel of which contacts HP turbine 228. Outer liner assembly 282 and inner liner assembly 280 are joined together to form combustion section 226. Combustion section 226 is attached to an inner casing 284 and an outer casing 286. In a space 288 radially inward from inner casing 284, various components are positioned. For example, a support bearing 290 and an oil seal assembly 292. Additionally, similar spaces along engine 120 also include other similar components, such as, but not limited to oil sumps, accessory gearboxes, power gearbox, and transfer gearboxes, which also benefit from well-placed oil delivery to these components. In the example embodiment, support bearing 290 and oil seal assembly 292 are both fed respective continuous oil jet streams 247 from respective nozzle assemblies 243, one or both of which include boundary layer injection insert 249. Referring to FIG. 4, nozzle assembly 243 and boundary layer injection insert 249 are configured to supply oil jet streams 247 adapted to the particular application to which they are directed. For example, a first nozzle 293 of nozzle assembly 243 is configured to supply support bearing 290 with a well-defined, high-integrity pencil stream targeted to a particular spot where cooling and lubrication are important. A second nozzle 294 of nozzle assembly 243 is configured to supply a holder 296 for oil seal assembly 292 with a widely broomed spray of oil for cooling purposes. The widely broomed spray provides cooling benefits, which are improved over a pencil stream.

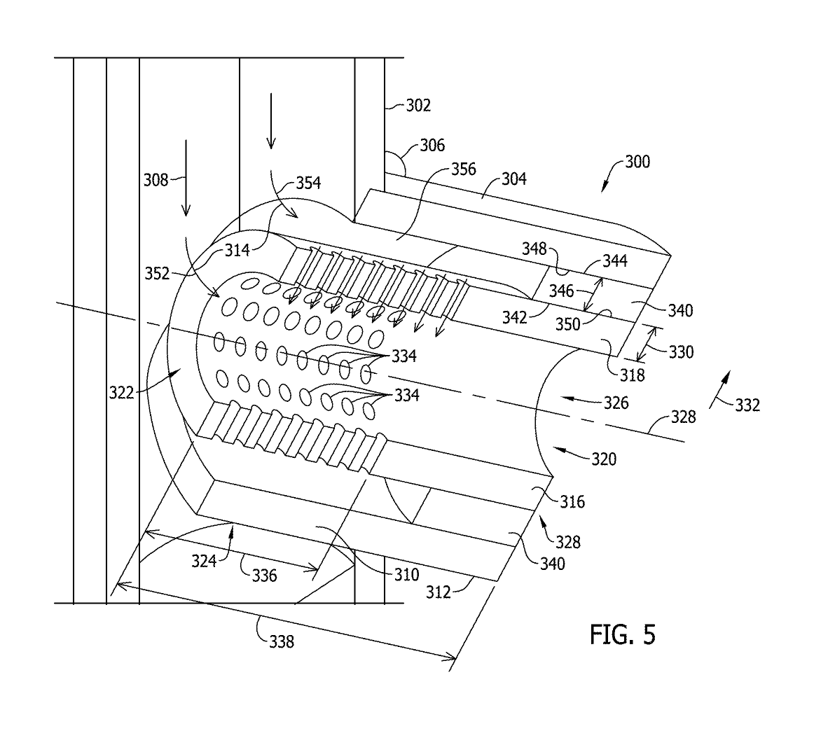

FIG. 5 is a perspective cutaway view of a boundary layer injection insert assembly 300 including boundary layer injection insert 249 (shown in FIG. 2) in accordance with an example embodiment of the present disclosure. In the example embodiment, a lubricating oil supply line 302 includes an oil supply nozzle 304 that branches off of lubricating oil supply line 302 at a first angle 306. Oil supply nozzle 304 receives a main flow 308 of oil from lubricating oil supply line 302. In an embodiment, a downstream portion 310 of a sidewall 312 of oil supply nozzle 304 extends into lubricating oil supply line 302 to “scoop” a flow 314 of oil from lubricating oil supply line 302. “Scooping” flow 314 in this fashion directs flow 314 into oil supply nozzle 304.

Boundary layer injection insert assembly 300 includes an insert tube 316 including an insert body 318 and a central bore 320 extending through insert body 318 from an inlet opening 322 positioned at a first end 324 of insert body 318 to an outlet opening 326 positioned at a second end 328 of insert body 318 opposite first end 324. In various embodiments, insert body 318 is approximately cylindrical about a longitudinal axis 329 and includes a thickness 330 in a radial direction 332 orthogonal to longitudinal axis 329. First end 324 includes a plurality of injection holes 334 extending through thickness 330 for a first distance 336 along a length 338 of insert body 318. In the example embodiment, first distance 336 is less than length 338. In one embodiment, injection holes 334 are radially oriented. In other embodiments, injection holes 334 are non-uniformly directed with respect to others of injection holes 334. Additionally, injection holes 334 may be uniformly or non-uniformly spaced with respect to each other.

Boundary layer injection insert assembly 300 further includes an annular spacer 340 at least partially surrounding second end 328. Annular spacer 340 includes a radially inner surface 342 and a radially outer surface 344 spaced apart by a thickness 346 of annular spacer 340. A radially outer surface 344 of annular spacer 340 is configured to engage a radially inner surface 348 of oil supply nozzle 304. A radially inner surface 342 of annular spacer 340 is configured to engage a radially outer surface 350 of insert body 318. In some embodiments, insert body 318 and annular spacer 340 are integrally formed.

During operation, main flow 308 enters oil supply nozzle 304 and is split into a first portion 352, which is directed down central bore 320 and a second portion 354, which is directed into an annular space 356 surrounding first end 324. Second portion 354 is directed through plurality of radially oriented injection holes 334. Because second portion 354 enters central bore 320 radially inwardly through insert body 318, any laminar flow along central bore 320 is disrupted by second portion 354. The radially inward flow also eliminates local recirculation in the main flow of first portion 352 and corrects any skewness of velocity and turbulent energy profiles, which are key contributors to oil jet brooming. First portion 352 and second portion 354 mix in first end 324 and second end 328 before exiting outlet opening 326. By injecting second portion 354 and correcting the flow in first portion 352, the jet stream integrity is improved. The requirements for upstream geometry and a length-to-diameter ratio (L/D) requirement can be relaxed, and oil lubricating and supply system 245 and oil supply nozzle 304 can be designed more compact to meet increasingly compact design spaces. Furthermore, oil injection in the boundary layer reduces pressure losses in oil supply nozzle 304. This reduction in pressure loss through oil supply nozzle 304 can reduce a size of the lube oil pump and still supply same amount of oil.

FIG. 4 is a side cutaway view of insert body 318 in accordance with an example embodiment of the present disclosure. Plurality of injection holes 334 are formed in first end 324 in circumferentially spaced rows 402 that extend axially along first end 324. In various embodiments, plurality of injection holes 334 in each of rows 402 are axially aligned. In other embodiments, axially adjacent injection holes 334 are spaced circumferentially with respect to each other. Additionally, spacing between plurality of injection holes 334 may be spaced different distances from each other. In various embodiments, plurality of injection holes 334 are of uniform size and direction, however, providing injection holes 334 having different sizes provides tailored treatment of the main flow through first end 324 such that the velocity and turbulence energy profiles of oil supply nozzle 304 are corrected based on the application. Similarly, at least some of plurality of injection holes 334 may be canted off of a straight radial direction to impart additional flow components to second portion 354 that are able to reach and/or affect the velocity and turbulence energy profiles of oil supply nozzle 304. In various embodiments, annular spacer 340 (shown in FIG. 3) is formed as a flange 404 extending outwardly from second end 328 and configured to engage oil supply nozzle 304 (shown in FIG. 3) to secure insert body 318 to oil supply nozzle 304 (shown in FIG. 3) and maintaining an annular space between oil supply nozzle 304 and insert body 318.

A treatment 406 along an edge 408 of outlet opening 326 facilitates contouring the oil stream exiting outlet opening 326. Treatment 406 may include chamfering, angling, modifying the smoothness, creating a knife-edge, and the like, to facilitate sharpening the exiting stream into a narrow directed stream or shaping the exiting stream to create a fanning or brooming stream exiting outlet opening 326. A replaceable insert body 318 permits modifying the stream characteristics to address issues with oil placement of components without having to replace entire nozzles and/or headers.

In some embodiments, intentional brooming is desired. As opposed to a concentrated stream of fluid, brooming may be used to diffuse the stream to cover a larger area of the target. This more diffuse stream may be used to facilitate cooling a component in addition to or instead of just providing lubrication.

Instead of hitting a specific bearing or carbon seal or oil scoop, it may be desirable shoot oil into a tube that has air circulating and that goes through a very hot environment. In such a case, the jet may be configured to broom extensively to cool the inside of the tube. In some embodiments, injection holes 334 are sized, spaced, and directed to improve the solidity and/or the integrity of the jet, however in other embodiments, injection holes 334 are sized, spaced, and directed to increase the brooming of the jet. For example, injection holes 334 are tailored to specific axial, circumferential, radial directions or some tuned combination of those to obtain the shape of the stream desired.

Although described with reference to an oil lubricating and supply system for a gas turbine engine, boundary layer injection insert assembly may be used with any fluid and does not necessarily need to be used in conjunction with rotating machinery.

The above-described boundary layer injection insert assembly provides an efficient apparatus for improving an oil jet stream exiting an oil nozzle and being directed to a specific location in a gas turbine engine. Specifically, the above-described fluid nozzle includes a boundary layer injection insert assembly that can be, for example, pressed into an opening of an oil nozzle to improve the oil nozzle oil jet stream integrity.

The above-described embodiments of a nozzle insert and a boundary layer injection system provides a cost-effective and reliable means for improving an integrity of a fluid stream exiting the nozzle. More specifically, the insert and system described herein facilitate directing the fluid stream to specific points on a lubricated component or contouring the fluid stream into, for example, a fanned configuration for covering a larger area with lubricating fluid. As a result, the nozzle insert and a boundary layer injection system described herein facilitate operating machinery at higher temperatures and under greater load than previously permissible in a cost-effective and reliable manner.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A boundary layer injection insert assembly comprising:
an insert tube comprising an insert body and a central bore extending through said insert body from an inlet opening positioned at a first end to an outlet opening positioned at a second end of said insert body opposite said first end, said insert body approximately cylindrical about a longitudinal axis, said first end comprising a plurality of injection holes extending through said insert body for a first distance along a length of said insert body, said first distance being less than said length; and
an annular spacer at least partially surrounding said second end.

2. The insert assembly of claim 1, wherein said spacer and said insert body are integrally formed.

3. The insert assembly of claim 1, wherein said plurality of injection holes are radially oriented.

4. The insert assembly of claim 1, wherein said plurality of injection holes are non-orthogonally oriented with respect to the longitudinal axis.

5. The insert assembly of claim 1, wherein at least some of said plurality of injection holes include an edge treatment that includes at least one of chamfering, angling, modifying the smoothness, and a knife-edge to facilitate sharpening a stream exiting the insert tube into a narrow directed stream or shaping the stream exiting the insert tube to create a fanning or brooming stream.

6. The insert assembly of claim 1, wherein said inlet opening and said plurality of injection holes each receive a portion of a flow of pressurized fluid.

7. The insert assembly of claim 6, wherein said first end of said insert body channels a first portion of the flow of pressurized fluid approximately axially through said central bore.

8. The insert assembly of claim 6, wherein said plurality of injection holes direct a second portion of the flow of pressurized fluid radially into the flow of the first portion.

9. The insert assembly of claim 1, wherein said annular spacer comprises a radially inner surface and a radially outer surface spaced apart by a thickness of said annular spacer, said radially outer surface of said annular spacer configured to engage a radially inner surface of a nozzle bore.

10. The insert assembly of claim 1, wherein said annular spacer comprises a radially inner surface and a radially outer surface spaced apart by a thickness of said annular spacer, said radially inner surface of said annular spacer configured to engage a radially outer surface of said insert body.

11. An oil nozzle assembly comprising:
a hollow elongate body coupled in flow communication to a source of a pressurized lubricating oil;
a boundary layer injection insert coupled to an inner surface of said body, said boundary layer injection insert comprising:
an insert tube comprising:
an insert body;
a central bore extending through said insert body from an inlet opening positioned at a first end of said insert body to an outlet opening positioned at a second end of said insert body, said second end opposite said first end, said insert body extending circumferentially about a longitudinal axis and comprising a thickness in a radial direction orthogonal to the longitudinal axis;
a plurality of injection holes extending through the thickness for a first distance along a length of said insert body, said first distance being less than said length; and
an annular spacer at least partially surrounding said second end.

12. The oil nozzle assembly of claim 11, wherein said plurality of injection holes extend radially inwardly through said insert body.

13. The oil nozzle assembly of claim 11, wherein said plurality of injection holes extend non-orthogonally with respect to the longitudinal axis through said insert body.

14. The oil nozzle assembly of claim 11, wherein said plurality of injection holes are formed of a uniform diameter.

15. The oil nozzle assembly of claim 11, wherein said plurality of injection holes are aligned axially with respect to adjacent injection holes.

16. The oil nozzle assembly of claim 11, wherein said annular spacer comprises a radially inner surface and a radially outer surface spaced apart by a thickness of said annular spacer.

17. A gas turbine engine comprising:
a core engine configured to generate a flow of high energy combustion gases;
a fan assembly powered by a power turbine driven by the combustion gases; and
a lubricating system configured to channel a flow of pressurized lubricating fluid to one or more components of the gas turbine engine, said lubricating system comprising:
a nozzle comprising:
a hollow elongate nozzle body coupled in flow communication with a source of a pressurized lubricating fluid;
a boundary layer injection insert coupled to an inner surface of said nozzle body, said boundary layer injection insert comprising:
an insert body comprising:
a central bore extending through said insert body between an inlet opening and an outlet opening, said insert body extending circumferentially about a longitudinal axis and comprising a thickness in a radial direction orthogonal to the longitudinal axis;
a plurality of injection holes extending through the thickness for a first distance along a length of said insert body, said first distance being less than said length; and
a flange at least partially surrounding a portion of said insert body, said flange configured to couple said insert body to said nozzle body.

18. The gas turbine engine of claim 17, wherein at least some of said plurality of injection holes extend through said insert body at least one of radially with respect to the longitudinal axis and non-orthogonally with respect to said longitudinal axis.

19. The gas turbine engine of claim 17, wherein at least some of said plurality of injection holes are sized non-uniformly with respect to other injection holes of said plurality of injection holes.

20. The gas turbine engine of claim 17, wherein at least some of said plurality of injection holes are spaced non-uniformly with respect to other injection holes of said plurality of injection holes.

21. The gas turbine engine of claim 17, wherein at least some of said plurality of injection holes are directed non-uniformly with respect to other injection holes of said plurality of injection holes.

22. The gas turbine engine of claim 17, wherein said insert body divides at least a portion of the flow of pressurized lubricating fluid into a first stream and a second stream, said first stream is directed through the inlet opening into the central bore, said second stream is directed through the plurality of injection holes into the central bore.

23. The gas turbine engine of claim 22, wherein the second stream reduces local recirculation in the first stream and modifies a skewness of at least one of a velocity profile of the first stream and a kinetic energy profile of the first stream.

24. The gas turbine engine of claim 17, wherein said outlet opening comprises an edge treatment configured to adjust an integrity of the first stream and the second stream as they exit said outlet opening.

25. The gas turbine engine of claim 17, wherein said radial holes comprises an edge treatment configured to adjust an integrity of the first stream and the second stream as they exit said outlet opening.

26. The gas turbine engine of claim 17, wherein the gas turbine engine comprises a geared turbofan engine.
